(19) United States
(12) Patent Application Publication
(10) Pub. No.: US 2025/0143258 A1
(43) Pub. Date: May 8, 2025

(54) APPARATUSES, SYSTEMS, AND METHODS FOR CONTROLLING ONE OR MORE ASSEMBLIES OF AN ENERGY GENERATION SYSTEM

(71) Applicant: Silicon Ranch Corporation, Nashville, TN (US)

(72) Inventors: Nicholas G.J. de Vries, Alameda, CA (US); Michael Baute, Whites Creek, TN (US)

(21) Appl. No.: 19/015,247

(22) Filed: Jan. 9, 2025

Related U.S. Application Data
(63) Continuation of application No. 17/885,083, filed on Aug. 10, 2022, now Pat. No. 12,225,887.
(62) Division of application No. 17/357,526, filed on Jun. 24, 2021, now Pat. No. 12,201,092.
(60) Provisional application No. 63/043,132, filed on Jun. 24, 2020.

(51) Int. Cl. A01K 3/00; H02S 20/32; H02S 50/00

(52) U.S. Cl. CPC A01K 3/00; H02S 20/32; H02S 50/00

(57) ABSTRACT

Apparatuses, systems, and methods are provided for controlling one or more assemblies of an energy generation system. The method may include selecting at least a portion of the one or more assemblies, transmitting at least one control signal associated with the selected at least a portion of the one or more assemblies, receiving the control signal at a communication module of the one or more assemblies, and modifying an operational parameter of the one or more assemblies responsive to the received control signal to avoid contact between the one or more assemblies and obstacles. The operational parameter may be associated with a position of the at least a portion of the one or more assemblies relative to a ground surface. The operational parameter may additionally or alternatively be a range of angle of the at least a portion of the one or more assemblies.

A portion of the disclosure of this patent document contains material that is subject to copyright protection. The copyright owner has no objection to the reproduction of the patent document or the patent disclosure, as it appears in the U.S. Patent and Trademark Office's files or records, but otherwise reserves all copyright rights whatsoever.

### CROSS-REFERENCES TO RELATED APPLICATIONS

This application claims the benefit of U.S. Patent Application No. 63/043,132 filed Jun. 24, 2020; U.S. patent application Ser. No. 17/357,526 filed Jun. 24, 2021; and U.S. patent application Ser. No. 17/885,083 filed Aug. 10, 2022. The foregoing applications are incorporated by reference herein in their entireties.

### BACKGROUND

Solar panels and other energy generation devices may have moveable components, which may result in said components encountering and/or contacting one or more obstacles while in use. This may endanger the device components as well as any surrounding objections, such as agriculture and livestock, which may be impacted and/or injured by a collision with the moveable components. What is needed then are apparatuses, systems, and methods to control one or more operations of an energy generation system to prevent such damage.

### BRIEF SUMMARY

The present disclosure relates generally to embodiments of apparatuses, systems, and methods for controlling one or more assemblies of an energy generation system. The system may include a photovoltaic design and system management platform capable of co-locating solar energy generation and agriculture and livestock, such as sheep and cattle.

Aspects of the present disclosure relate to an energy assembly apparatus including at least one solar cell configured to capture solar energy. In some embodiments, the at least one assembly apparatus may further include an energy storage configured to store at least a portion of solar energy captured by the at least one solar cell, a panel actuator configured to manipulate an operational parameter of the at least one solar cell, a communication module configured to receive at least one control signal, and a processor configured to control the panel actuator to manipulate the operational parameter of the at least one solar cell based at least in part upon the at least one control signal. The operational parameter may be a current or expected presence status adjacent to the at least one assembly apparatus and/or the at least one solar cell. The presence status may be a livestock presence indication, and the panel actuator may manipulate an orientation of the at least one solar cell responsive to a control signal received from the processor responsive to the operational parameter.

Further aspects of the present disclosure relate to an energy generation system comprising one or more energy generation assemblies disposed in one or more livestock paddocks, wherein the one or more livestock paddocks are divided into a plurality of regions. The one or more energy generation assemblies may be disposed within each of the plurality of regions. Each of the energy generation assemblies may comprise at least one solar cell configured to capture solar energy, a panel actuator configured to manipulate the position of the at least one solar cell within a range of angles from parallel to a ground surface, a communication module configured to receive the control signal from the computing device, and a processor configured to control the panel actuator to manipulate position of the at least one solar cell, and a computing device for selectively controlling the one or more energy generation assemblies. The computing device, such as a network and/or processor, may be configured to designate one or more current use regions from among the plurality of regions, wherein the one or more current use regions correspond to regions associated with current or expected use by livestock. The computing device may be further configured to generate respective control signals to each of the one or more energy generation assemblies to place each energy generation assembly in either: a standard tracking mode if the generation assembly is disposed outside of the one or more current use regions or a presence mode if the generation assembly is disposed within the one or more current use regions. In the standard tracking mode, the at least one solar cell may be positioned at any angle with respect to a ground surface. In the presence mode, the at least one solar cell at any angle may be positioned at a restricted range of angles as compared to the standard tracking mode in order to avoid contact with livestock.

Still further aspects of the present disclosure relate to a method of controlling one or more assemblies of an energy generation system. The method may include selecting at least a portion of the one or more assemblies, transmitting at least one control signal associated with the selected at least a portion of the one or more assemblies, receiving the control signal at the one or more assemblies, and modifying an operational parameter of the one or more assemblies responsive to the received control signal to avoid contact between the one or more assemblies and livestock. The operational parameter may be associated with a position of the at least a portion of the one or more assemblies relative to a ground surface. The operational parameter may additionally or alternatively be a range of angles of the at least a portion of the one or more assemblies. For example, the operational parameter may be any range of angles from parallel to the ground surface when operating in a standard tracking mode. The operational parameter may additionally or alternatively be a precise range of angles from parallel to the ground surface when operating in a presence mode.

The one or more assemblies may be associated with a plurality of paddocks. The method may include transitioning livestock between a plurality of paddocks by designating a current use area, wherein the transitioning includes placing at least a portion of the one or more assemblies into a presence mode and placing at least a portion of the one or more assemblies into a standard tracking mode from a presence mode based upon status of the one or more assemblies as being within a current use area.

Additional aspects of the present disclosure relate to a method of controlling an energy generation system comprising a plurality of assemblies located in a useable space. The method includes dividing the useable space into a plurality of regions and capturing solar energy using a plurality of assemblies disposed within one or more of the plurality of regions. The method further includes designating a current use region of the plurality of regions, the current use region corresponding to a region associated with current or expected use by livestock. The method may include controlling an operational setting of at least one assembly of the plurality of assemblies disposed within the current use region and selectively adjusting an operational setting of the at least one assembly of the plurality of assemblies.

The current use region may comprise a livestock paddock with a current presence status. In said embodiments, the method includes obtaining a selection of one or more of the plurality of assemblies associated with the current use region and providing a control signal to place the assemblies associated with the current use region into a presence mode of operation, which may include limiting movement of the assemblies to avoid contact with livestock. The method may further include determining that a next livestock paddock is available for use, moving livestock within the current use region to the next livestock paddock, and designating the next livestock paddock as the current use region. The method may further include selecting at least a portion of the one or more of the plurality of assemblies associated with the former current use region and transmitting at least one control signal to the assemblies located therein to place the assemblies into a standard tracking mode responsive.

Numerous other objects, features, and advantages of the present invention will be readily apparent to those skilled in the art upon a reading of the following disclosure when taken in conjunction with the accompanying drawings.

### BRIEF DESCRIPTION OF THE SEVERAL VIEWS OF THE DRAWINGS

FIG. 1 illustrates an exemplary embodiment of a partial block network diagram according to aspects of the present disclosure.

FIG. 2 illustrates an exemplary embodiment of a block diagram of an assembly according to aspects of the present disclosure.

FIG. 3 illustrates an exemplary embodiment of a partial side view of an assembly operating in a tracking configuration according to aspects of the present disclosure.

FIG. 4 illustrates an exemplary embodiment of a partial side view of an assembly operating in a presence configuration according to aspects of the present disclosure.

FIG. 5 illustrates an exemplary embodiment of a graph of an impact of presence modes of energy yield according to aspects of the present disclosure.

FIG. 6 illustrates an exemplary embodiment of a partial block diagram of rotation grazing for a ten-paddock area according to aspects of the present disclosure.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

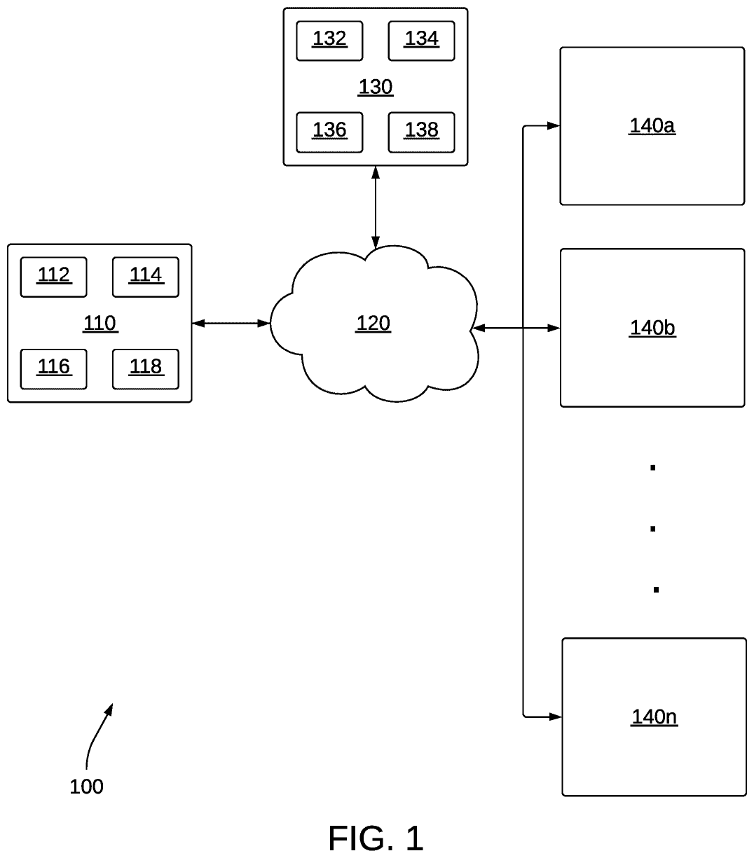

Referring generally to FIGS. 1-6 in conjunction with the description and illustrations herein, various exemplary apparatuses, systems, and methods are provided according to aspects of the present disclosure.

### Energy Generation System Network

Aspects of the present disclosure relate to an energy generation system network. FIG. 1 illustrates an exemplary embodiment of a partial block network diagram for an energy generation system according to aspects of the present disclosure. The system 100 is a simplified partial network block diagram reflecting a functional communicative configuration implementable according to aspects of the present disclosure. The system 100 may include a user device 110 coupleable to a network 120, a server 130 coupleable to the network 120, and one or more energy generation assemblies 140a, 140b, . . . , 140n coupleable to the network 120. One or more assemblies 140a, 140b, . . . , 140n may include a photovoltaic panel or tracker in various embodiments. The server 130 may be a standalone device or in combination with at least one other external component either local or remotely communicatively coupleable with the server 130 (e.g., via the network 120).

In one exemplary embodiment, the network 120 includes the Internet, a public network, a private network, or any other communications medium capable of conveying electronic communications. Connection between elements or components of FIG. 1 may be configured to be performed by wired interface, wireless interface, or combination thereof, without departing from the spirit and the scope of the present disclosure. At least one of the user device 110 and/or the server 130 may include a communication unit 118, 138 configured to permit communications for example via the network 120.

In one exemplary operation, at least one of user device 110 and/or server 130 is configured to store one or more sets of instructions in a volatile and/or non-volatile storage element 114, 134. The one or more sets of instructions may be configured to be executed by a microprocessor 112, 132 to perform operations corresponding to the one or more sets of instructions.

In various exemplary embodiments, at least one of the user device 110 and/or server 130 is implemented as at least one of a desktop computer, a server computer, a laptop computer, a smart phone, or any other electronic device capable of executing instructions. The microprocessor 112, 132 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result.

One or more computing component and/or functional element may be configured to operate remotely and may be further configured to obtain or otherwise operate upon one or more instructions stored physically remote from the user device 110, server 130, and/or functional element (e.g., via client-server communications and/or cloud-based computing).

At least one of the user device 110 and/or server 130 may include a display unit 116, 136. The display unit 116, 136 may be embodied within the computing component or functional element in one embodiment and may be configured to be either wired to or wirelessly interfaced with at least one other computing component or functional element. The display unit may be configured to operate, at least in part, based upon one or more operations of the described herein, as executed by the microprocessor 112, 132.

### Energy Generation Assemblies

As earlier detailed, the energy generation system includes at least one energy generation assemblies 140 for capturing energy. An energy generation assembly 140 or group of assemblies 140 may include or take the form of one or more photovoltaic modules or arrays, such as described for example in U.S. Pat. No. 10,116,256, which is hereby incorporated by reference in its entirety.

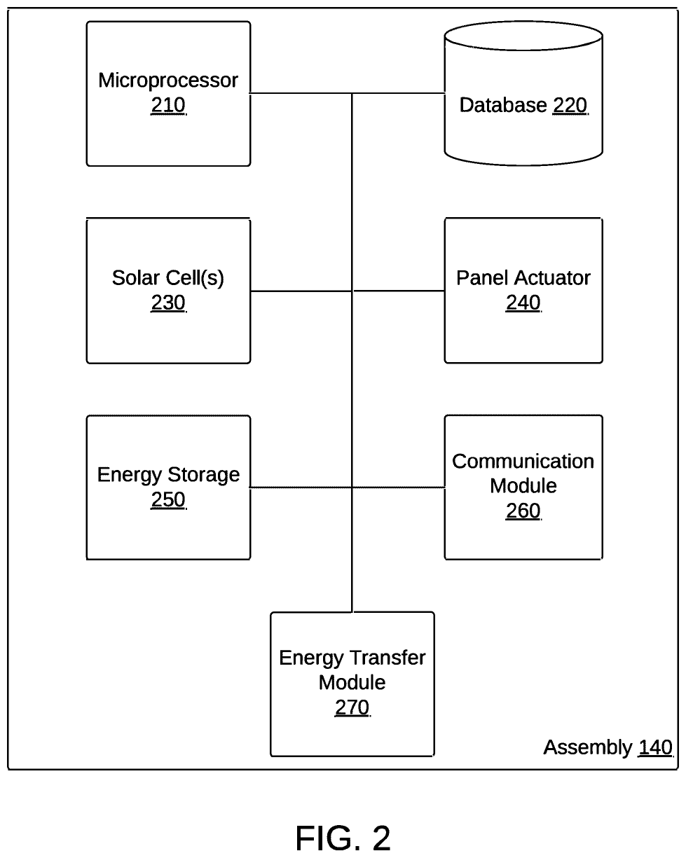

FIG. 2 illustrates an exemplary embodiment of a block diagram of an assembly 140 according to aspects of the present disclosure. An assembly 140 may include one or more of a microprocessor 210, a database 220, at least one cell 230, a panel actuator 240, an energy storage 250, a communication module 260 and/or an energy transfer module 270. One or more of the microprocessor 210, the database 220, the at least one cell 230, the panel actuator 240, the energy storage 250, the communication module 260 and/or the energy transfer module 270 may be communicatively and/or conductively coupleable to at least one other elements via a communicative and/or conductive bus. Like microprocessor 112, 132, the microprocessor 210 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result.

The at least one cell 230 of the energy generation assembly 140 may be used to capture energy and to convert the captured energy into a storable form, which may be stored, for example, at the energy storage 250. The at least one cell 230 may comprise at least one solar cell 230, which may be a photovoltaic cell or other solar energy capture element. In some embodiments, the at least one solar cell 230 may be or include a non-flat solar tile. Although described with reference to a solar cell herein, it should be appreciated that at least one cell 230 may be any form of energy capturing or generation device. For example, at least one cell 230 may include a wind turbine, hydroelectric turbine, or any other form of energy capture or generation element.

The least one solar cell 230 of the assembly 140 may be positioned at any angle with respect to a ground surface upon or within which the assembly 140 is located. The position of the at least one solar cell 230 may be manipulated by the panel actuator 240 of the assembly 140. For example, the panel actuator 240 may be configured to manipulate the position of the at least one solar cell 230 within a range of angles from parallel to the ground surface. In some embodiments, the panel actuator 240 is configured to adjust and/or set an operating position of the at least one solar cell 230 to, for example, capture a maximum amount of solar energy and/or to avoid one or more obstacles within a physical movement range of the at least one solar cell 230. The panel 240 may be controlled and/or operated by the processor 210.

The assembly 140 may be configured to transmit and/or receive one or more of operation parameters, settings, configuration, usage information, current and/or historical data, hardware information or hardware update information, or any other information via a communication module 260. The communication module 260 may be configured to be communicatively coupleable to one or more elements via a wired connection, a wireless connection, or combination thereof. In various embodiments, the communication module 260 may be configured to communicate with another communication module 260 of another assembly 140 within a wired and/or wireless communication range (for example, form a daisy-chain style configuration and/or to form a redundant communication configuration). At least one communication module 260 may be configured to communicate via the network 120 (for example to one or more of the user device 110 and/or server 130) including during operation to enable and/or perform one or more functions described herein. For instance, the network 120 and/or user device 110 may be capable of sending a signal to the communication module 260 that directs the panel actuator to adjust the position of the at least one solar cell 230. The signal may be manually generated from, for example, a human using the user device 110, and/or the signal may be automatically generated in response to certain conditions or stimuli, such as detection of a presence (or expected presence) of obstacles that may contact the at least one solar cell 230.

The instructions used to perform or enable one or more operations described herein may be included within database 220. The database 220 may be at least one volatile and/or non-volatile storage mediums configured to store at least one set of information used to perform or enable one or more operations described herein. Although illustrated as being physically embodied within the assembly 140, at least a portion of the database 220 may be or include at least one storage physically and/or logically remote from the assembly 140 (for example, in the case of distributed or cloud-based storage, either in whole or in part).

The energy storage 250 of the assembly 140 may be an energy storage element capable of storing at least a portion of energy captured or generated by the at least one solar cell 230. The energy storage 250 may be a battery or capacitive storage element in various embodiments which is configured to receive charging power from the at least one solar cell 230. The assembly 140 may include an energy transfer module 270 configured to transmit and/or to receive power to/from the assembly 140. For example, the energy transfer module 270 may be configured to output power generated by the assembly 140 that is currently being generated by the assembly 140 and/or is stored at the energy storage 250. In various embodiments, a group of assemblies 140 may share one or more energy storages 250 local to and/or remote from each assembly 140 and may transmit generated power (via, for example, energy transfer module(s) 270) to the one or more energy storages 250 for storage during operation.

Various environmental and operational conditions might impact power generated by one or more assemblies 140. For example, solar energy incident on various assemblies 140, ambient temperature, and/or other factors may impact power generated by each assembly. Depending upon the number and type of assemblies 140 used, the generated power may vary widely in terms of generated voltage and/or current. Changes in temperature, solar irradiance, and shading, either from near objects such as trees or far objects such as clouds, may cause power losses. Other factors, such as device age, particle collection on a surface of the assembly 140, and/or device degradation, might negatively affect performance of an assembly 140.

### Operation Modes for Energy Generation Assemblies

As earlier detailed, the at least one solar cell 230 of the assembly 140 may be in any position and/or angle with respect to the ground surface upon or within which the assembly 140 is located. This configuration is especially advantageous when the assembly 140 is located in an area with potential or existing obstacles that may contact and/or damage the at least one solar cell 230. For example, this configuration is particularly beneficial for co-locating solar energy generation and agriculture, such as livestock, that may contact the assembly 140. Such contact may endanger the assembly 140 as well as the agriculture and livestock.

In some embodiments, the assembly 140 may have different operating configurations or “modes” based on the presence, expected presence, or lack thereof of obstacles, such as livestock. For example, when no livestock is present, the assembly 140 may be configured to operate in a “standard tracking mode.” In the standard tracking mode, contact with livestock is not a concern, and thus, the at least one solar cell 230 of the assembly 140 may positioned at any angle with respect to the ground surface (e.g., anywhere along a full range of motion). In contrast, in the presence or expected presence of livestock, the assembly may be configured to operate in a “presence mode.” In the presence mode, contact with livestock or animals is a concern, and thus, the at least one solar cell 230 of the assembly 140 may be restricted in position as compared to the free range of position in the standard tracking mode. While the term livestock is used herein to illustrate the disclosed embodiments, it should be appreciated that term is exemplary and that any obstacle, including for example crops, are contemplated without departing from the spirit and scope of the present disclosure.

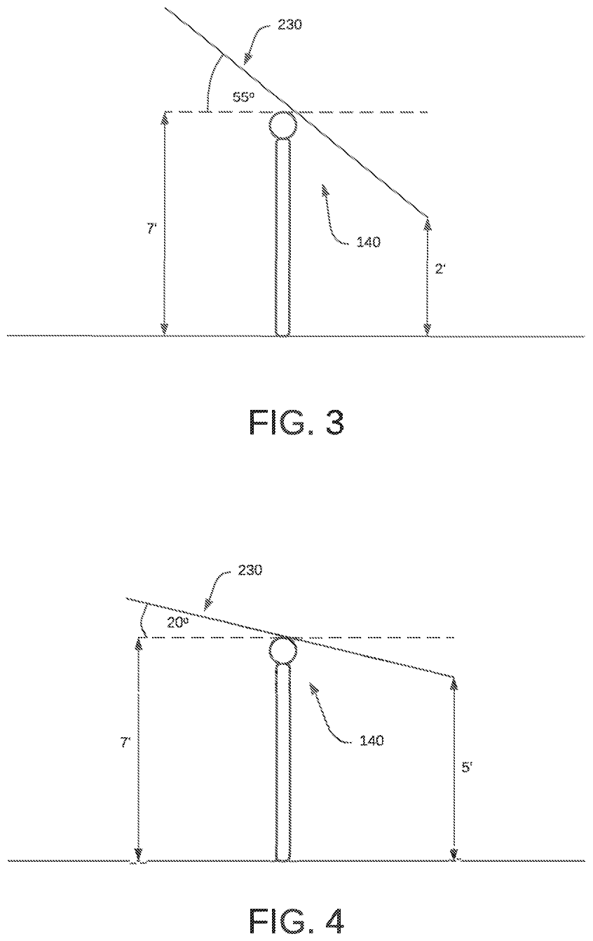

Embodiments of the standard tracking mode and presence mode are illustrated in FIGS. 3 and 4. Specifically, FIG. 3 illustrates an exemplary embodiment of a partial side view of an assembly operating in the standard tracking mode according to aspects of the present disclosure. In the standard tracking mode, there is no concern of collision, and thus, the at least one solar cell 230 of the assembly 140 may be adjusted between any angle relative to parallel to a ground surface (shown as +/−55 degrees in FIG. 3). That is, the at least one solar cell 230 may be at any position from about 0 degrees from parallel to the ground surface (i.e., horizontal) to about +/−90 degrees from parallel to the ground surface (i.e., vertical). More specifically, the at least one solar cell 230 may be positioned at about 0 degrees, +/−10 degrees, +/−20 degrees, +/−30 degrees, +/−40 degrees, +/−50 degrees, +/−60 degrees, +/−70 degrees, +/−80 degrees, +/−90 degrees from parallel to the ground surface, and any subranges thereof or therebetween. In various embodiments, the at least one solar cell 230 of an assembly 140 in the standard tracking mode may be configured to actively track the motion of the sun to generate maximum energy.

FIG. 4 illustrates an exemplary embodiment of a partial side view of an assembly operating in the presence mode according to aspects of the present disclosure. When the assembly 140 is in the presence mode, the angle of the at least one solar cell 230 is restricted due to concern for collision. That is, while the at least one solar cell 230 may be at any angle in the standard tracking mode, the at least one solar cell 230 is restricted to a smaller angle with respect to parallel to the ground surface in the presence mode. For example, as illustrated in FIGS. 3 and 4, the at least one solar cell 230 of the assembly 140 may be adjusted, for example, from +/−55 degrees in the standard tracking mode (FIG. 3) to a smaller angle of +/−20 degrees in the presence mode (FIG. 4). In some embodiments, the at least one solar cell 230 of an assembly 140 in the presence may be configured to actively track the motion of the sun so long as the angle does not result in collision with livestock.

Based on the moveability of the at least one solar cell 230, the range of distance from the solar cell 230 to the ground surface may be varied during operation. For example, in the standard tracking mode embodiment illustrated by FIG. 3, a +/−55-degree angle of the solar cell 230 relative to the ground surface results in a lower end of the solar cell 230 being two feet from the ground surface, which may not be enough clearance for livestock. In contrast, in the presence mode embodiment illustrated by FIG. 4, a +/−20-degree angle of the solar cell 230 relative to the ground surface results in a lower end of the solar cell 230 being five feet from the ground surface, which may be sufficient to permit animals, such as cattle, to freely graze and roam beneath the solar cells 230 without being impacted by the solar cells 230. Other heights and angles may be used without departing from the spirit and scope of the present disclosure. The angle of the at least one solar cell 230 in the presence mode may be based on the nature of the agriculture with which the assembly 140 is co-located. For example, the angle of the solar cell 230 in the presence mode would be greater in the presence of a smaller animal, such as sheep, than in the presence of a larger animal, such as cattle, because greater clearance to the ground is needed for cattle relative to sheep.

A clearance limit to ground surface may be implemented, such as a two-foot height requirement from the solar cell 230 to the ground surface in the standard tracking mode and a five-foot height requirement in the presence mode, although other heights may be implemented according to factors such as terrain, height of an object to avoid, or any other criteria. In various embodiments, a solar cell 230 may be placed in a stow configuration of zero degrees relative to parallel to a ground surface. The solar cell 230 may be, for example, seven feet above the ground surface in an exemplary stow embodiment. Stowing the solar cell 230 may place the assembly 140 in its safest position, for example from wind or animal interaction.

In various exemplary embodiments, operation in the presence mode may reduce power production. For example, in a +/−55-degree standard tracking mode as compared to a +/−20-degree presence mode, overall production may be reduced by 5.7% assuming a ten livestock paddock configuration with equal distribution of livestock time across each paddock area. If operated in the presence mode for 10% of the time, there may be a 0.57% annual loss in production in this scenario, assuming a seven-foot-tall assembly 140 having a 33% Ground Coverage Ratio (GCR) Bifacial system. At standard operation, the standard tracking mode may produce an output of 1897 MWh/MWp whereas the presence mode may result in an output of 1777 MWh/MWp. Thus, assuming 10% presence mode operation, a total average production would be 1885 MWh/MWp.

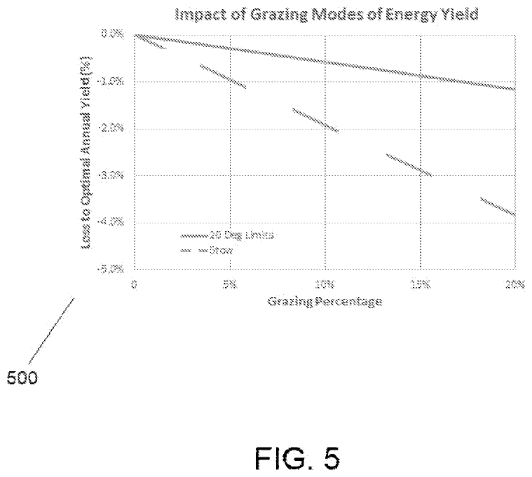

FIG. 5 illustrates an exemplary embodiment of a graph of the impact of presence (e.g., grazing) modes of energy yield according to aspects of the present disclosure. Having livestock share space with power generation systems may involve multiple trade-offs. For example, as illustrated by the graph 500, clearance from grade of the ground surface may be a dimension to eliminate animal to equipment interaction. One solution to permit both power generation and animals in a common space or paddock may be provided by increasing a pile height of the solar cells 230 from the ground surface. However, such implementation might significantly increase the cost of both the power generation system hardware and installation cost.

### Co-Location of Energy Generation Assemblies and Livestock Paddocks

In some embodiments, one or more energy generation assemblies 140 are disposed within one or more livestock paddocks. A paddock as detailed herein may be any designated space or area, and is not necessarily limited to enclosures, equal areas, or any other limitation on size, shape, location, and/or usage. Implementations consistent with the present disclosure may permit livestock movement through the one or more livestock paddocks of the energy generation system using one or more physical and/or virtual livestock fencing configurations integrated into a tracker control function, for example, of various inverter blocks. These configurations may include geofencing applications, virtual fencing, fenceless control systems, Global Positioning System (GPS) ear tags, or any other control scheme implementable by an energy generation system described herein. In various embodiments a property may be subdivided into paddocks by inverter blocks, or sub-blocks, using these various interior fencing systems to accommodate one or more forms of “rotational grazing.” Examples of rotational grazing may include Adaptive Multi-Paddock Grazing (AMP Grazing), management intensive rotational grazing, holistic planned grazing, mob grazing, or the like.

Livestock may be rotated through each paddock as needed, based at least in part upon environmental conditions, forage quality and quantity, livestock production considerations, or the like. One or more tracker modules may be applied to the assembly 140 and may be activated, for example, by a rancher when a particular area or paddock is being opened to livestock. Additionally or alternatively, one or more tracker modules may be capable of independently and/or dynamically determining when livestock or other possible obstructions are within range of a paddock and transitioning the assemblies 140 within said paddock into the presence mode.

The presence mode may be selected by a user (for example, a rancher) for a particular paddock and corresponding assemblies 140 using an app installed at the user device 110 or an interface accessible to the user via the user device 110 such as a webpage via network 120. The user device 110 may be configured to transmit at least one parameter and/or control signal to the corresponding assemblies 140 according to the designated mode, for example via the network 120. Similarly, a user may designate one or more areas and corresponding assemblies 140 into a standard tracking mode when livestock are not present, and the designation may similarly be transmitted from the user device 110 via the network 120.

In a rotating ten-paddock example, a particular assembly 140 may be configured to operate in the standard tracking mode for 90% of the time and in the presence mode for 10% of the time assuming an equal distribution of livestock time across each paddock area. Further assuming equal distribution of assemblies 140 in the ten paddocks, only 10% of the assembles are in the presence mode at any time, and the remaining 90% of the assemblies 140 may be maintained in the standard tracking mode, such that these assemblies 140 are capable of angular adjustment within an entire range of motion, without risk of damage to assembly 140 or livestock.

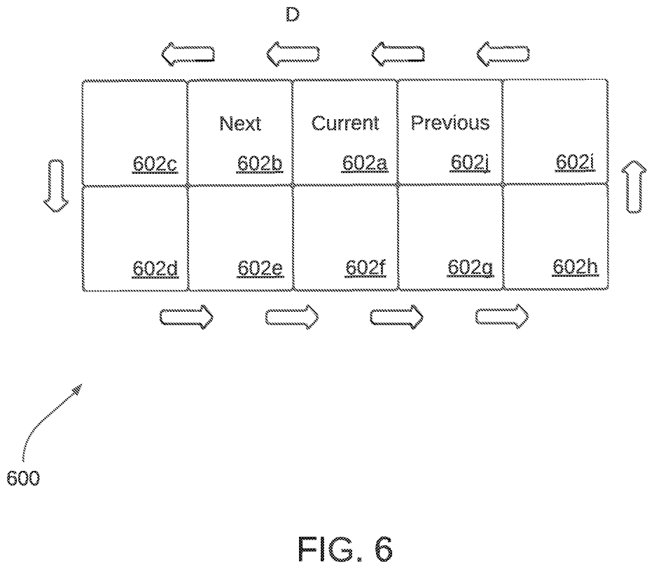

FIG. 6 illustrates an exemplary embodiment of a partial block diagram of a rotation grazing system for a ten-paddock area according to aspects of the present disclosure. A paddock may be defined by one or more commonly controlled assemblies 140, a common electrical solar array, and may be fenced or virtually fenced. The system 600 includes ten paddocks 602a, 602b, 602c, 602d, 602e, 602f, 602g, 602h, 602i, and 602j. While ten paddocks are illustrated, it should be appreciated that any number of paddocks may be used without departing from the spirit and scope of the present disclosure.

A paddock 602a may be designated as a current usage area in the exemplary embodiment illustrated by FIG. 6. The current usage area paddock may include one or more assemblies 140 associated therewith which may be selectively designated in the presence mode relating to current or expected livestock usage. The current usage area paddock may be configured to move between the paddocks 602 in a direction D in, for example, a clockwise or counterclockwise manner, although any ordering or direction may be used. Transition between paddocks may be configured to be evenly distributed in timing or may be separately timed according to a predetermined or dynamically determined basis. When transitioning from a previous area, such as the paddock 602a in the embodiment illustrated by FIG. 6, a user (such as a rancher) may designate the next current area, such as 602b, along direction D. Additionally or alternatively, the system may be configured to transition between current area paddocks 602 without requiring human intervention, such as based upon an automatic timing or herding configuration. For example, each livestock may have at least one device (for example, an ear tag or a collar with a proximity or geolocation transmitter) affixed to their respective bodies that may trigger the presence mode if the at least one device comes within a predetermined distance of the current usage area and/or one or more assemblies and may trigger the standard tracking mode if the at least one device exceeds the predetermined distances of the current usage area and/or one or more assemblies.

Once a next current usage area is determined, a control signal may be transmitted to the one or more assemblies 140 (e.g., as received at a communication module 260 thereof) to designate an operating mode depending upon whether the one or more assemblies 140 are disposed with a current usage area or not. The control signal may be sent by a user or by the network 120. The control signal may transition or maintain the one or more assemblies 140 in the presence mode if the one or more assemblies 140 are disposed within the current usage area. Once the control signal indicating the presence mode is received at each assembly 140 in the current usage area, the microprocessor 210 of the assembly 140 may be configured to control the panel actuator 240 to restrict an angle of the solar cells 230 to a particular angle for livestock clearance, such as +/−20-degrees from parallel to ground, although other angle ranges may be used.

Meanwhile, the control signal may transition or maintain the one or more assemblies 140 in the standard tracking mode if the one or more assemblies 140 are disposed outside of the current usage area (e.g., in an area which had previously been designated as the current use area but is no longer). Once the control signal indicating the standard mode is received at each assembly 140 disposed outside of the current usage area, the microprocessor 210 of an assembly 140 may be configured to control the panel actuator 240 to position the solar cells 230 at any angle with respect to the ground surface. Although placed in the standard tracking mode, the one or more assemblies 140 may be configured to detect the presence of an object (such as by motion sensing, radar, or any other detection method) which might contact at least a portion of the assembly 140 during operation and may be configured to adjust one or more angle(s) of operation or other operational parameter so as to avoid the object in real-time and/or in a predetermined manner.

For a next destination paddock, the associated assemblies 140 may be in a standard tracking mode. A user, such as a rancher, or an electronic component may evaluate forage quality, water provisions, paddock fencing, and/or other element(s) of the paddock and then may selectively command the one or more assemblies 140 to enter a presence mode and may further verify that the paddock and the assemblies 140 are ready for animals. A user, such as a rancher, or an electronic component may return the one or more assemblies of the previous paddock area to a standard tracking mode when all animals are confirmed to have left the paddock. A rancher may prepare paddocks for animals, including defining a control state of one or more paddocks, and may escort animals when conditions for presence are ready. In said embodiments, livestock may graze or be present in one or more of the paddocks, while forage in the other paddocks begins regrowing.

Methods of controlling an energy generation system comprising one or more energy generation assemblies are also contemplated herein. The method may include selecting at least a portion of the one or more assemblies, transmitting at least one control signal associated with the selected at least a portion of the one or more assemblies, receiving the control signal at a communication module of the one or more assemblies, and modifying an operational parameter of the one or more assemblies responsive to the received control signal to avoid contact between the one or more assemblies and livestock. The transmittal of the at least one control signal and the selection of the at least a portion of the one or more assemblies may be performed using a user device.

The operational parameter may be associated with a position of the at least a portion of the one or more assemblies relative to a ground surface. The operational parameter may provide a vertical clearance distance between a lowest portion of a section of the one or more assemblies (e.g., the lowest portion of the one or more solar cells) and a ground surface. The operational parameter may additionally or alternatively be a range of angle of the at least a portion of the one or more assemblies, such as the position of the one or more solar cells. The operational parameter may additionally or alternatively be placing the assembly in either the presence mode or the standard tracking mode.

The one or more assemblies may be disposed within a plurality of paddocks. In said embodiments, the method may include transitioning livestock between a plurality of paddocks, wherein any paddock containing livestock is designated as a current use area. In such embodiments, the method may include selecting at least a portion of the one or more assemblies and transmitting at least one control signal to the selected assemblies to place the selected assemblies into either a presence mode if disposed within the current use area or a standard tracking mode if disposed outside of a current use area.

Implementations consistent with the present disclosure may further include a method of operating an energy generation system comprising one or more assemblies disposed within a useable space. The method includes dividing the useable space into a plurality of regions and capturing solar energy using a plurality of assemblies within one or more of the plurality of regions. The method further includes designating a current use region of the plurality of regions, wherein the current use region corresponds to a region associated with current or expected use by livestock. The method may include controlling an operational setting of at least one assembly of the plurality of assemblies, the at least one assembly associated with the current use region, and selectively adjusting an operational setting of at least one assembly of the plurality of assemblies associated status change in relation to a current use region.

The method may include transmitting a control signal to the one or more of the plurality of assemblies to place the one or more of the plurality of assemblies associated with the current use region into a presence mode of operation. The presence mode may include limiting movement of at least a portion of the one or more of the plurality of assemblies to avoid contact between livestock within the current use region and the one or more of the plurality of assemblies. The method may further include determining that a next livestock paddock is available for use, moving livestock within the current use region to the next livestock paddock, and designating the next livestock paddock as the current use region. The method may further include selecting at least a portion of the one or more of the plurality of assemblies associated with the livestock paddock, transmitting at least one control signal to the at least a portion of the one or more of the plurality of assemblies associated with the livestock paddock, and placing the at least a portion of the one or more of the plurality of assemblies associated with the livestock paddock into a standard tracking mode responsive to the at least one control signal.

Implementations consistent with the present disclosure may further include an assembly apparatus including at least one solar cell configured to capture solar energy, an energy storage configured to store at least a portion of solar energy captured by the at least one solar cell, a panel actuator configured to manipulate an operational parameter, such as position, of the at least one solar cell, a communication module configured to receive at least one control signal, and a processor configured to control the panel actuator to manipulate the operational parameter of the at least one solar cell based at least in part upon the at least one control signal. The operational parameter may be a current or expected presence status adjacent to the at least one solar cell. The presence status may be a livestock presence indication, and the panel actuator may manipulate an orientation of the at least one solar cell responsive to a control signal received from the processor responsive to the operational parameter. The panel actuator may limit movement of the at least one solar cell when the assembly apparatus operates in a presence mode. The panel actuator may allow full range of motion of the at least one solar cell when the assembly apparatus operates in a standard tracking mode.

In addition to providing one or more operations previously described herein, implementations consistent with the present disclosure may provide numerous further advantages. For example, one or more sets of weather station instrumentation may be implemented or improved, including eddy covariance flux towers, soil moisture sensors, soil temperature sensors (e.g., share temperature and/or full sun temperature not under module measurement), and/or various configurations of remote sensing of a surrounding ecosystem function. The eddy covariance flux towers may be configured to directly or indirectly measure Greenhouse Gas (GHG) flux between atmosphere and soil on solar land, for example by measuring a flux value associated with one or more of NO2, CO2, H2O, NH3, or any other measurable GHG.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims. The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. An assembly apparatus, comprising:
at least one solar cell configured to capture solar energy;
an energy storage configured to store at least a portion of solar energy captured by the at least one solar cell;
a panel actuator configured to manipulate an operational parameter of the at least one solar cell;
a communication module configured to receive at least one control signal; and
a processor configured to control the panel actuator to manipulate the operational parameter of the at least one solar cell based at least in part upon the at least one control signal.

2. The assembly apparatus of claim 1, wherein the operational parameter is a current or expected presence status adjacent to the at least one solar cell.

3. The assembly apparatus of claim 2, wherein the presence status is a livestock presence indication, and further wherein the panel actuator is configured to manipulate position of the at least one solar cell responsive to a control signal received from the processor responsive to the operational parameter.

4. The assembly apparatus of claim 3, wherein the panel actuator is configured to position the at least one solar cell at any angle with respect to a ground surface when the assembly apparatus operates in the standard tracking mode.

5. The assembly apparatus of claim 4, wherein the panel actuator is configured to limit position of the at least one solar cell from parallel to the ground surface when the assembly apparatus operates in a presence mode.

6. The assembly apparatus of claim 3, wherein the processor is configured to designate whether the assembly apparatus is within a current use area based at least in part on the control signal, and to operate the assembly apparatus in a presence mode or a standard tracking mode based upon the designation.

7. An energy generation system, comprising:
livestock paddocks disposed in a plurality of regions;
one or more energy generation assemblies located in each of the plurality of regions, each of the energy generation assemblies comprising:
at least one solar cell configured to capture solar energy,
a panel actuator configured to manipulate the position of the at least one solar cell within a range of angles from parallel to a ground surface,
a communication module configured to receive the control signal from the computing device, and
a processor configured to control the panel actuator to manipulate position of the at least one solar cell; and
a computing device for selectively controlling the one or more energy generation assemblies, the computing device configured to:
designate one or more current use regions from among the plurality of regions, wherein the one or more current use regions correspond to regions associated with current or expected use by livestock, and
generate respective control signals to each of the one or more energy generation assemblies to place each energy generation assembly in either:
a standard tracking mode if the generation assembly is disposed outside of the one or more current use regions, wherein the panel actuator of the generation assembly is configured to position the at least one solar cell at any angle within the range of angles from parallel to the ground surface or
a presence mode if the generation assembly is disposed within the one or more current use regions, wherein the panel actuator of the generation assembly is configured to restrict the position of the at least one solar cell from parallel to the ground.

8. The energy generation system of claim 7, wherein for each of the energy generation assemblies, the respective processor is configured to designate whether the assembly is disposed within the one or more current use regions based at least in part on the control signal, and to operate the assembly in the presence mode or the standard tracking mode based upon the designation.

9. The energy generation system of claim 8, wherein the computing device is further configured to:
determine the movement or expected movement of livestock from a first of the plurality of regions that is the one or more current use regions to a second of the plurality of regions;
designate the second of the plurality of regions as the one or more current use regions based on the determining of the movement or expected movement of the livestock from the first of the plurality of regions to the second of the plurality of regions; and
generate respective control signals to the one or more energy generation assemblies disposed in the second of the plurality of regions to place the one or more energy generation assemblies disposed in the second of the plurality of regions into the presence mode.

10. The energy generation system of claim 9, wherein the computing device is further configured to:
cease to designate the first of the plurality of regions as the one or more current use regions based on the based on the determining of the movement or expected movement of the livestock from the first of the plurality of regions to the second of the plurality of regions; and
generate respective control signals to the one or more energy generation assemblies located in the first of the plurality of regions to place the one or more energy generation assemblies disposed in the first of the plurality of regions into the standard tracking mode.

11. The energy generation system of claim 8, wherein when the respective processor designates that the assembly is disposed within the one or more current use regions, the respective processor operates the assembly in the presence mode.

12. The energy generation system of claim 8, wherein when the respective processor designates that the assembly is disposed outside of the one or more current use regions, the respective processor operates the assembly in the standard tracking mode.

13. The energy generation system of claim 7, wherein the at least one solar cell is +/−50 degrees from parallel to the ground surface in the standard tracking mode.

14. The energy generation system of claim 7, wherein the at least one solar cell is between +/−60 degrees from parallel to the ground surface in the standard tracking mode.

15. The energy generation system of claim 7, wherein the range of angles is configured to provide a vertical clearance distance between a lowest portion of a section of the at least one solar cell and a ground surface.

16. The energy generation system of claim 7, wherein the computing device is configured to transition between the one or more current use regions without manual input.

17. The energy generation system of claim 7, wherein the computing device is configured to transition between the one or more current use regions based on received signals corresponding to a sensed presence or movement of livestock there between.

18. A method of controlling one or more assemblies of an energy generation system, the method comprising:
selecting at least a portion of the one or more assemblies;
transmitting at least one control signal associated with the selected at least a portion of the one or more assemblies;
receiving the control signal at a communication module of the at least a portion of one or more assemblies; and
modifying an operational parameter of the at least a portion of one or more assemblies responsive to the received control signal to avoid contact between the one or more assemblies and livestock.

19. The method of claim 18, wherein the operational parameter is associated with a position of the at least a portion of the one or more assemblies relative to a ground surface.

20. The method of claim 19, wherein the operational parameter is a range of angle of the at least a portion of the one or more assemblies.

21. The method of claim 20, wherein the operational parameter is +/−20 degrees from parallel to the ground surface when operating in a presence mode.

22. The method of claim 20, wherein the operational parameter is between +/−50 to +/−60 degrees from parallel to the ground surface when operating in a standard tracking mode.

23. The method of claim 19, wherein the operational parameter is configured to provide a vertical clearance distance between a lowest portion of a section of the at least a portion of one or more assemblies and a ground surface.

24. The method of claim 18, wherein the at least a portion of the one or more assemblies are associated with a livestock paddock of a plurality of paddocks.

25. The method of claim 18, wherein the at least one control signal is transmitted from a user device.

26. The method of claim 25, wherein the selecting the at least a portion of the one or more assemblies is performed using the user device.

27. The method of claim 18, further comprising: transitioning livestock between a plurality of paddocks by designating a current use area, wherein the transitioning includes placing at least a portion of the one or more assemblies into a presence mode and placing at least a portion of the one or more assemblies into a standard tracking mode from the presence mode based upon status of the one or more assemblies as being within a current use area.

28. A method of controlling one or more assemblies of an energy generation system, comprising:
dividing a useable space into a plurality of regions;
capturing solar energy using a plurality of assemblies located at one or more of the plurality of regions;
designating a current use region of the plurality of regions, the current use region corresponding to a region associated with current or expected use by livestock;
controlling an operational setting of at least one assembly of the plurality of assemblies, the at least one assembly associated with the current use region; and
selectively adjusting an operational setting of at least one assembly of the plurality of assemblies associated status change in relation to a current use region.

29. The method of claim 28, wherein the designating the current use region comprises associating a livestock paddock with a current presence status, and further comprising obtaining a selection of one or more of the plurality of assemblies associated with the livestock paddock and providing a control signal to the one or more of the plurality of assemblies to place the one or more of the plurality of assemblies associated with the livestock paddock into a presence mode of operation.

30. The method of claim 29, wherein placing the one or more of the plurality of assemblies associated with the livestock paddock into a presence mode of operation includes limiting movement of at least a portion of the one or more of the plurality of assemblies to avoid contact between livestock within the livestock paddock and the one or more of the plurality of assemblies.

31. The method of claim 30, further comprising:
determining that a next livestock paddock is available for use;
moving livestock within the current use region to the next livestock paddock; and
designating the next livestock paddock as the current use region.

32. The method of claim 31, further comprising:
selecting at least a portion of the one or more of the plurality of assemblies associated with the livestock paddock;
transmitting at least one control signal to the at least a portion of the one or more of the plurality of assemblies associated with the livestock paddock; and
placing the at least a portion of the one or more of the plurality of assemblies associated with the livestock paddock into a standard tracking mode responsive to the at least one control signal.

33. A method of controlling one or more assemblies of an energy generation system, the method comprising:
providing one or more assemblies, each of the one or more assemblies including:
one or more solar cells configured to capture solar energy,
a panel actuator configured to manipulate the position of the one or more solar cells-within a range of angles from parallel to a ground surface,
a communication module configured to receive a control signal, and
a processor configured to control the panel actuator to manipulate position of the one or more solar cells;
selecting at least a portion of the one or more assemblies;
transmitting at least one control signal to the selected one or more assemblies;
receiving the at least one control signal at the selected one or more assemblies, wherein the at least one control signal places the selected one or more assemblies in either:
a standard tracking mode, wherein the panel actuator is configured to position the one or more solar cells at any angle within the range of angles from parallel to the ground surface or
a presence mode, wherein the panel actuator is configured to restrict the position of the one or more solar cells; and
placing the selected one or more assemblies in either the standard tracking mode or the presence mode in response to the received at least one control signal.

34. The method of claim 33, further comprising:
defining a current use region encompassing at least a portion of the one or more assemblies based on the presence or expected presence of livestock; and
sending the at least one control signal to place at least a portion of the selected one or more assemblies that are disposed within the current use region into the presence mode.

35. The method of claim 34, further comprising sending the at least one control signal to place at least a portion of the selected one or more assemblies that are disposed outside of the current use region into the standard tracking mode.

36. The method of claim 33, wherein the range of the angles of the one or more solar cells is +/−50 degrees from parallel to the ground surface when the at least a portion of the one or more assemblies are in the standard tracking mode.

37. The method of claim 33, wherein the range of the angles of the one or more solar cells is between +/−60 degrees from parallel to the ground surface when the at least a portion of the one or more assemblies are in the standard tracking mode.

38. The method of claim 33, wherein the range of the angles is configured to provide a vertical clearance distance between a lowest solar cell of the one or more solar cells of the at least a portion of one or more assemblies and the ground surface.

39. The method of claim 33, wherein the at least a portion of the one or more assemblies are disposed in a plurality of livestock paddocks.

40. The method of claim 33, wherein the at least one control signal is transmitted from a user device.

41. The method of claim 40, wherein the selecting the at least a portion of the one or more assemblies is performed using the user device.

42. The method of claim 33, further comprising defining a current use region encompassing at least a portion of the one or more assemblies based on the presence or expected presence of livestock, placing at least a portion of the one or more assemblies that are disposed within the current use region into the presence mode, and placing at least a portion of the one or more assemblies that are disposed outside of the current use region into the standard tracking mode.

43. A method of controlling an energy generation system, the method comprising:
providing an energy generation system including one or more assemblies disposed in a plurality of regions, each assembly comprising:
one or more solar cells configured to capture solar energy,
a panel actuator configured to manipulate the position of the one or more solar cells-within a range of angles from parallel to a ground surface,
a communication module configured to receive a control signal, and
a processor configured to control the panel actuator to manipulate position of the one or more solar cells;
capturing solar energy using the one or more assemblies;
selecting one or more of the plurality of regions as a current use region based on the presence or expected presence of livestock in the one or more of the plurality regions;
transmitting at least one control signal to the one or more assemblies; and
receiving the at least one control signal at the one or more assemblies, wherein the at least one control signal places at least a portion of the one or more assemblies in either:
a standard tracking mode if the at least a portion of the one or more assemblies are disposed outside of the current use region, wherein in the standard tracking mode, the panel actuator is configured to position the one or more solar cells at any angle within the range of angles from parallel to the ground surface or
a presence mode if the at least a portion of the one or more assemblies are disposed within the current use region, wherein in the presence mode, the panel actuator is configured to restrict the position of the one or more solar cells.

44. The method of claim 43, wherein the range of the angles of the one or more solar cells is between +/−50 degrees from parallel to the ground surface in the standard tracking mode.

45. The method of claim 43, wherein the range of the angles of the one or more solar cells is between +/−60 degrees from parallel to the ground surface in the standard tracking mode.

46. The method of claim 43, further comprising:
determining the movement or expected movement of livestock from a first of the plurality of regions that is the current use region to a second of the plurality of regions;
selecting the second of the plurality of regions as the current use region based on the determining of the movement or expected movement of the livestock from the first of the plurality of regions to the second of the plurality of regions; and
transmitting a control signal to one or more of the plurality of assemblies disposed in the second of the plurality of regions to place the one or more of the plurality of assemblies disposed in the second of the plurality of regions into the presence mode.

47. The method of claim 46, further comprising:
selecting at least a portion of the one or more of the plurality of assemblies disposed in the first of the plurality of regions;
transmitting at least one control signal to the at least a portion of the one or more of the plurality of assemblies disposed in first of the plurality of regions; and
placing the at least a portion of the one or more of the plurality of assemblies disposed in the first of the plurality of regions into the standard tracking mode responsive to the at least one control signal.
